(19) United States
(12) Patent Application Publication
(10) Pub. No.: US 2026/0237122 A1
(43) Pub. Date: Aug. 13, 2026

(54) METHOD AND DEVICE FOR MODIFYING BACKGROUND MODEL OF 3D SVM IN CONJUNCTION WITH DISTANCE SENSOR

(71) Applicant: HYUNDAI MOBIS CO., LTD., Seoul (KR)

(72) Inventor: Nam Hyun AHN, Yongin-si (KR)

(73) Assignee: HYUNDAI MOBIS CO., LTD., Seoul (KR)

(21) Appl. No.: 19/404,653

(22) Filed: Dec. 1, 2025

(30) Foreign Application Priority Data
Feb. 13, 2025 (KR) 10-2025-0019021

(51) Int. Cl. G06T 11/60; G01S 15/08; G01S 15/931

(52) U.S. Cl. CPC G06T 11/60; G01S 15/08; G01S 15/931; G01S 2015/932

(57) ABSTRACT

A method of modifying a background model of a 3D surround view monitor (SVM) in conjunction with a distance sensor includes receiving distance information collected through an ultrasonic sensor, converting the ultrasonic sensor distance information into two-dimensional coordinates using external parameters of the ultrasonic sensor, determining a shape of a bottom surface of a background model of a 3D SVM according to the two-dimensional coordinates, generating the background model of the 3D SVM based on the shape of the bottom surface, generating a vehicle model of the 3D SVM based on vehicle data based on the background model of the 3D SVM, determining whether to activate a parking distance warning (PDW) function based on the ultrasonic sensor distance information, generating a PDW graphic when the PDW function is activated, coupling a 3D SVM screen with a PDW screen, and outputting the 3D SVM.

### CROSS REFERENCE TO RELATED APPLICATION

The present application claims priority to Korean Patent Application No. 10-2025-0019021, filed on Feb. 13, 2025, the entire contents of which is incorporated herein for all purposes by this reference.

### BACKGROUND

### Field

The present disclosure relates to a method and device for modifying a background model of a 3D surround view monitor (SVM) in conjunction with a distance sensor.

### Description of the Related Art

A surround view monitor (SVM) or an around view monitor (AVM) is a driver assistance system for visualizing a surrounding environment of a vehicle in two dimensions (2D) or three dimensions (3D) to intuitively identify position of an actual vehicle and obstacles and provides a field of view at various angles, such as a top view, a bird's-eye view, a side view, etc. Such an SVM technology is primarily used in parking and low-speed traveling situations of a vehicle and aims to secure a field of view around the vehicle and reduce blind spots, thereby improving driver safety.

Such an SVM can provide audio and visual warnings when obstacles are detected in conjunction with ultrasonic sensors and cameras, and in this regard, an ultrasonic sensor-based parking distance warning (PDW) is a technology that attaches ultrasonic sensors for measuring a distance to the exterior of a vehicle and provides distance information to a driver, and the distance information between the vehicle and surrounding obstacles acquired from the ultrasonic sensors can be displayed graphically on an SVM screen to provide convenience for a driver during parking.

However, since the conventional 3D SVM technologies typically use a fixed background model shape, when positions of an actual object and a wall of a background model are different, the object is distorted, making it difficult to perceive a distance of the actual object. In order to correct this distortion, the distance information can be provided to the driver through the function like the PDW, but this is a simple graphical effect, thereby reducing immersion and causing a sense of incongruity with the background model, potentially leading to confusion for the driver.

Recently, as more diverse sensors are being increasingly added to vehicles, there is a growing need to enhance the performance of existing functions through the coupling of these sensors.

### SUMMARY

The present disclosure has been made in efforts to solve the above problems and is directed to enhancing the realism of a 3D surround view monitor (SVM) screen through various expansion technologies to enhance the competitiveness of 3D SVMs.

In addition, the present disclosure is directed to assisting drivers in parking by providing them with more reliable and realistic images.

Objects of the present disclosure are not limited to the above objects, and other objects will be able to be clearly understood by those skilled in the art based on the following description.

According to one embodiment of the present disclosure, there is provided a method of modifying a background model of a 3D surround view monitor (SVM) in conjunction with a distance sensor, wherein each operation is performed by at least one processor of a computer system, including receiving distance information collected through an ultrasonic sensor, converting the received distance information from the ultrasonic sensor into two-dimensional coordinates using external parameters of the ultrasonic sensor, determining a shape of a bottom surface of a background model of a 3D SVM according to the two-dimensional coordinates, generating the background model of the 3D SVM based on the shape of the bottom surface, generating a vehicle model of the 3D SVM based on vehicle data and the background model of the 3D SVM, determining whether to activate a parking distance warning (PDW) function based on the received distance information from the ultrasonic sensor, generating a PDW graphic when the PDW function is activated, coupling a 3D SVM screen with a PDW screen, and outputting the 3D SVM.

A device for modifying a background model of a 3D SVM in conjunction with a distance sensor according to one embodiment of the present disclosure is implemented by at least one processor of a computer system to perform each operation of the method of modifying a background model of a 3D SVM in conjunction with a distance sensor according to one embodiment of the present disclosure.

### BRIEF DESCRIPTION OF THE DRAWINGS

FIG. 1 is a flowchart showing a method of modifying a background model of a 3D surround view monitor (SVM) in conjunction with a distance sensor according to one embodiment of the present disclosure.

FIG. 2 is a schematic view showing parameters used in a sensor data conversion process according to one embodiment of the present disclosure.

FIG. 3 is a schematic view showing each ellipse parameter used in a process of determining a shape of a bottom surface of the background model of the 3D SVM according to one embodiment of the present disclosure.

FIG. 4 is a schematic view showing ellipse parameters of the second quadrant among the ellipse parameters of FIG. 3.

FIGS. 5A and 5B are views showing distortion of a wall of the background model of the 3D SVM according to one embodiment of the present disclosure and distortion according to positions of objects.

FIG. 6 is a schematic view showing a process of additionally correcting the ellipse parameters of the background model of the 3D SVM according to one embodiment of the present disclosure.

### DETAILED DESCRIPTION

Hereinafter, a method and device for modifying a background model of a 3D surround view model (SVM) in conjunction with a distance sensor of the present disclosure will be described in detail with reference to the accompanying drawings. Drawings introduced below are provided as examples so that the spirit of the present disclosure can be sufficiently conveyed to those skilled in the art. Accordingly, the present disclosure is not limited to the drawings presented below and may be specified in other forms. In addition, the same reference numerals denote the same components throughout the specification.

In this case, unless otherwise defined, technical and scientific terms used have the meaning commonly understood by those skilled in the art to which the present disclosure pertains, and the descriptions of well-known functions and configurations that may unnecessarily obscure the gist of the present disclosure will be omitted in the following description and the accompanying drawings.

In addition, a system refers to a set of components including devices, mechanisms, and units that are organized and interact regularly to perform necessary functions.

The present disclosure relates to a method and device for modifying a background model of a 3D surround view monitor (SVM) in conjunction with a distance sensor, which convert distance information from an object measured through an ultrasonic sensor into two-dimensional coordinates to determine a shape of a bottom surface of the background model of the 3D SVM, determine elliptical parameters constituting bottom surfaces of each of four groups divided into quadrants to generate the background model of the 3D SVM, thereby generating a vehicle model of the 3D SVM.

More specifically, the method and device for modifying a background model of a 3D SVM in conjunction with a distance sensor according to an embodiment of the present disclosure include coupling a distance recognition sensor to change the shape of the background model of the SVM in real time, generating the shape of the background model of the 3D SVM as a combined partial ellipse, and determining a weight inversely proportional to a distance when using distance sensor information to determine the shape of the background model of the SVM.

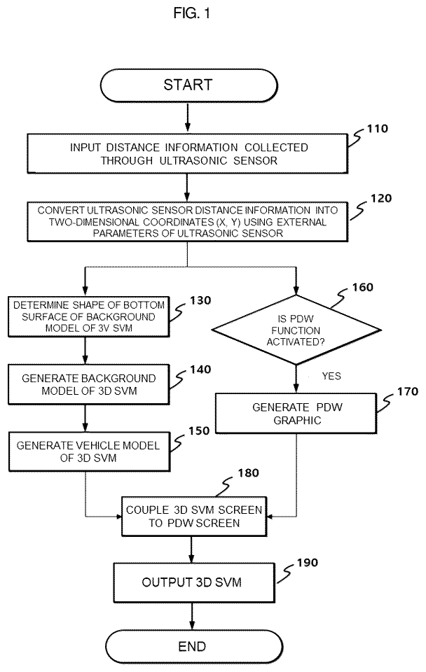

Regarding the above technical characteristics of the present disclosure, FIG. 1 is a flowchart showing a method of modifying a background model of a 3D surround view monitor (SVM) in conjunction with a distance sensor according to one embodiment of the present disclosure. A method of modifying a background model of a 3D SVM in conjunction with a distance sensor according to one embodiment of the present disclosure will be described in detail with reference to FIG. 1.

As shown in FIG. 1, a method of modifying a background model of a 3D SVM in conjunction with a distance sensor according to one embodiment of the present disclosure preferably includes an operation 110 of receiving distance information collected through an ultrasonic sensor, an operation 120 of converting ultrasonic sensor distance information into two-dimensional coordinates (x, y) using external parameters of an ultrasonic sensor, an operation 130 of determining a shape of a bottom surface of the background model of the 3D SVM according to the two-dimensional coordinates, an operation 140 of generating the background model of the 3D SVM based on the shape of the bottom surface, an operation 150 of generating a vehicle model of the 3D SVM based on vehicle data according to the background model of the 3D SVM, an operation 160 of determining whether to activate a parking distance warning (PDW) function based on the ultrasonic sensor distance information, an operation 170 of generating a PDW graphic when the PDW function is activated, an operation 180 of coupling a 3D SVM screen to a PDW screen, and an operation 190 of outputting the 3D SVM. In addition, each operation is performed by a device for modifying a background model of a 3D SVM in conjunction with a distance sensor, which is implemented with one or more processors of a computer system.

Each operation will be described in detail below.

In the operation 110 of receiving the distance information collected through the ultrasonic sensor, in order to measure a distance from an object, the ultrasonic sensor transmits an ultrasonic signal, receives a reflected signal, and calculates distance information to an object based on the signal. According to one embodiment of the present disclosure, multiple ultrasonic sensors rather than a single ultrasonic sensor may be used to collect surrounding environmental data to obtain information on a position and direction of an object.

In addition, external parameters of the ultrasonic sensor may be used to correct data collected by the ultrasonic sensor or provide additional information, and main external parameters may include sensor installation information such as installation locations and angles of the ultrasonic sensors, locations (e.g., a front, rear, and side surface or the like) in the vehicle, the relative arrangement between sensors, and the like, environmental variables such as temperature and media, a state of a vehicle such as a speed and direction of the vehicle, etc.

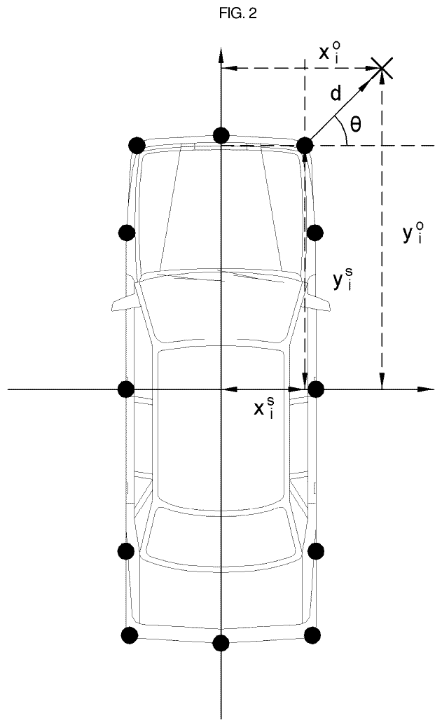

As described above, after the distance information collected through the ultrasonic sensor is received, the method proceeds to the operation 120 of converting the distance information of the ultrasonic sensor into two-dimensional coordinates (x, y) using the external parameters of the ultrasonic sensor. In this operation, the collected distance information of the ultrasonic sensor and the external parameters of the ultrasonic sensor are integrated, and more specifically, the collected distance information is converted into two-dimensional coordinates (x, y) by reflecting the installation location and angle of the ultrasonic sensor. The process of obtaining the two-dimensional coordinates (x, y) will be described in more detail below with reference to FIG. 2.

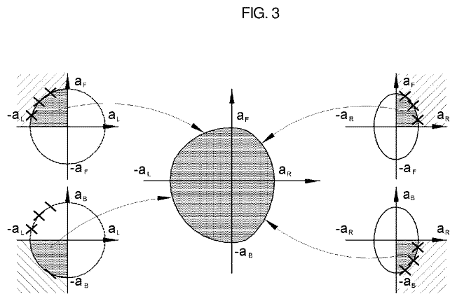

After a set of the two-dimensional data is received from the ultrasonic sensor through the above process, the process proceeds to determining the shape of the bottom surface of the background model of the 3D SVM according to the two-dimensional coordinates of the set of the two-dimensional data. The operation 130 of determining the shape of the bottom surface of the background model of the 3D SVM is a process of identifying and modeling the shape of the bottom surface based on data acquired through the ultrasonic sensor in 3D space, and in this operation, the bottom surface of the 3D space is clearly defined by combining the data obtained from the ultrasonic sensor with the external parameters. In this case, the ultrasonic sensor may receive distance signals from nearby obstacles, correct the distance signals with factors such as inclination of the vehicle, an installation angle of the ultrasonic sensor, and the like, and convert the corrected distance signals into bottom surface data. An algorithm of determining a shape of a bottom surface will be described in detail below with reference to FIGS. 3 to 6.

In the operation 130 of determining the shape of the bottom surface of the background model of the 3D SVM, the shape of the bottom surface is ultimately defined as a flat surface shape in 3D space, and once the shape of the bottom surface is completed, the background model of the 3D SVM is generated by generating the wall of the background model along the outline of the corresponding bottom surface (operation 140). That is, the operation 140 of generating the background model of the 3D SVM is a process for modeling a surrounding environment (e.g., roads, walls, buildings, and the like) of the vehicle and analyzing interactions with the vehicle, and consequently, the background model is visualized as a 3D spatial model of an area around the vehicle to provide a safe driving environment.

Next, the operation 150 of generating the vehicle model of the 3D SVM based on vehicle data according to the background model of the 3D SVM includes generating a vehicle model by projecting the vehicle onto the 3D space and performing modeling based on vehicle data such as a size, position, movement, and the like of the vehicle.

Meanwhile, the operation 160 of determining whether to activate the PDW function includes analyzing data obtained from the ultrasonic sensor to identify positions of obstacles around the vehicle and comparing a distance to the obstacle measured by the ultrasonic sensor with a preset safety distance to determine whether the obstacle exceeds the safety distance. When it is determined that the safety distance has been exceeded, the method proceeds to the next operation and performs the operation 170 of generating the PDW graphic. That is, the position and distance of the corresponding obstacle are displayed on the PDW screen to provide a visual representation.

Subsequently, the operation 180 of coupling the 3D SVM screen to the PDW screen and the operation 190 of outputting the 3D SVM are processes of integrating 3D spatial information and PDW-related data to provide an intuitive display to the driver. First, in the operation 180 of coupling the 3D SVM screen to the PDW screen, the top view generated from the 3D SVM is integrated with the obstacle data generated from the PDW, and more specifically, the PDW information (e.g., a position, distance, color, and the like of an obstacle) is additionally coupled on the 3D SVM screen (i.e., a 3D background model and a vehicle model). The coupled screen is output to a driver display or the like in the operation 190 of outputting the 3D SVM. Since the coupling between the 3D SVM screen and the PDW screen enables the driver to identify the situation around the vehicle at a glance, the driver may intuitively understand the positions of the vehicle and nearby obstacles in 3D space and the warning information of the PDW can enhances safety.

In addition, the device for modifying a background model of a 3D SVM in conjunction with a distance sensor according to one embodiment of the present disclosure is implemented by at least one processor of a computer system to perform each operation of the method of modifying a background model of a 3D SVM in conjunction with a distance sensor according to one embodiment of the present disclosure.

Accordingly, the method and device for modifying a background model of a 3D SVM in conjunction with a distance sensor according to one embodiment of the present disclosure have the advantage of enhancing the reliability of the SVM screen by realistically representing the background model of the 3D SVM.

FIG. 2 is a schematic view showing parameters used in a process of converting sensor data according to one embodiment of the present disclosure and shows the parameters used in the operation 120 of converting ultrasonic sensor distance information into the two-dimensional coordinates (x, y) using the external parameters of the ultrasonic sensor of FIG. 1. Hereinafter, the operation 120 of converting the ultrasonic sensor distance information into the two-dimensional coordinates (x, y) using the external parameters of the ultrasonic sensor of FIG. 1 will be described in a formula with reference to the parameters shown in FIG. 2.

In order to use distance values detected by the distance (ultrasonic) sensor in generating the background model of the SVM and the PDW, a process of converting the distance values into two-dimensional coordinates is required. The process of converting the distance (ultrasonic) sensor measurement values into two-dimensional coordinates with the center of the vehicle as the origin is performed using the parameters shown in FIG. 2, and this conversion process requires information on the installation location of the sensor, that is, ultrasonic sensor x coordinates x^{s}ᵢ and ultrasonic sensor y coordinates y^{s}ᵢ, which are two-dimensional coordinate values of the sensor, and a sensor optical axis angle θ, in addition to a sensor measurement value d.

In this regard, as shown in Equations 1 and 2 below, first, by obtaining the two-dimensional coordinate values (d cos θ, d sin θ) of an object with the center of the sensor as the origin using the sensor measurement value d and the sensor optical axis angle θ and then adding the two-dimensional location coordinates (x^{s}ᵢ, y^{s}ᵢ) of the sensor with the center of the vehicle as the origin to the corresponding coordinates, the two-dimensional coordinates of the object, that is, an object x-coordinate (x^{o}ᵢ) and an object y-coordinate (y^{o}ᵢ), may be obtained, respectively.

$${x}_{i}^{o} = {x}_{i}^{s} + d \times cos θ \qquad [ Equation 1 ]$$

$${y}_{i}^{o} = {y}_{i}^{s} + d \times sin θ \qquad [ Equation 2 ]$$

Hereinafter, the operation 130 of determining the shape of the bottom surface of the background model of the 3D SVM of FIG. 1 will be described in detail with reference to FIGS. 3 to 6.

FIG. 3 is a schematic view showing each ellipse parameter used in a process of determining a shape of a bottom surface of the background model of the 3D SVM according to one embodiment of the present disclosure.

By acquiring a set of 2D data set from the distance (ultrasonic) sensor, the shape of the background model of the 3D SVM may be determined. FIG. 3 shows a process of determining the shape of the bottom surface of the background model of the 3D SVM through the set of sensor data according to one embodiment of the present disclosure. As shown in FIG. 3, the bottom surface may be generated by partially coupling four ellipses, each of which has a different parameter. The 2D data acquired from the sensor is divided into four groups according to quadrants of a 2D coordinate system with the center of the vehicle as the origin, and each set of data includes parameters of each ellipse constituting the bottom surface, for example, a_{R} and a_{F} of the first quadrant, a_{L} and a_{F} of the second quadrant, a_{L} and a_{B} of the third quadrant, and a_{R} and a_{B} of the fourth quadrant are determined. When a bottom surface with elliptical parameters of a_{R}, a_{F}, −a_{L}, and −a_{B} is completed by partially coupling these four ellipses, the wall of the background model is generated along the outline of the corresponding bottom surface.

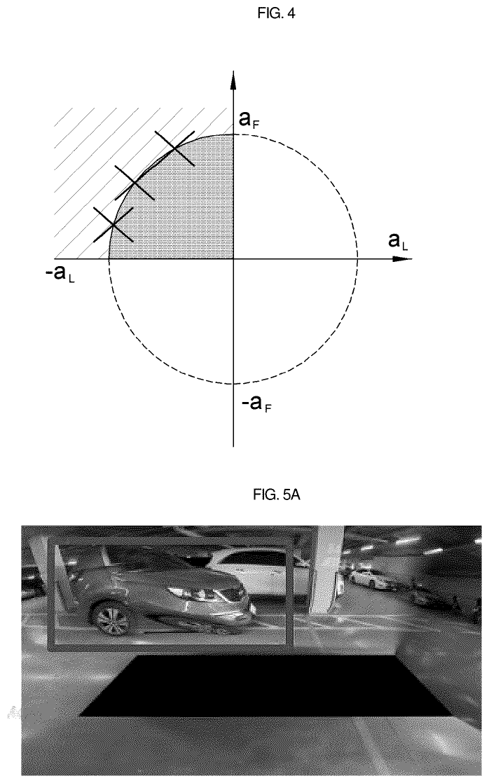

FIG. 4 is a schematic view showing elliptical parameters of the second quadrant among the elliptical parameters of FIG. 3, and the equation of the ellipse of the second quadrant is as in the following Equation 3.

$${Ax}^{2} + {By}^{2} = 1 ( A = \frac{1}{{a}_{L}^{2}} , B = \frac{1}{{a}_{F}^{2}} ) \qquad [ Equation 3 ]$$

(where a_{L} and a_{F} are half lengths of major and minor axes of the partial ellipse of the second quadrant, respectively).

In this regard, the process of determining parameters of each partial ellipse from each set of data may be sequentially performed using the following Equations 4 to 11.

First, the equation of an ellipse centered at the origin is determined by two parameters, that is, the lengths of the major and minor axes

$$( e . g . , {a}_{L} = \frac{1}{\sqrt{A}} and {a}_{F} = \frac{1}{\sqrt{B}}$$

in the second quadrant) as shown in the following Equation 4.

$${Ax}^{2} + {By}^{2} = 1 \qquad [ Equation 4 ]$$

Assuming that each data point is present on the ellipse, a squared error may be calculated as shown in the following Equation 5.

$${E}_{i} = {( {Ax}_{i}^{2} + {By}_{i}^{2} - 1 )}^{2} \qquad [ Equation 5 ]$$

A weighted sum wᵢ of errors for each data point may be used to obtain the total squared error of the following Equation 6.

$${E}_{Tot} = \sum {{w}_{i} ( {Ax}_{i}^{2} + {By}_{i}^{2} - 1 )}^{2} \qquad [ Equation 6 ]$$

Finally, by partially differentiating this as shown in the following Equations 7 and 8, parameters A and B that minimize the squared error may be obtained using the following Equations 9 and 10 (least squares error technique).

$$\frac{\partial {E}_{Tot}}{\partial A} = \sum 2 {w}_{i} {{x}_{i}^{2} ( {Ax}_{i}^{2} + {By}_{i}^{2} - 1 )}^{2} = 0 \qquad [ Equation 7 ]$$

$$\frac{\partial {E}_{Tot}}{\partial B} = \sum 2 {w}_{i} {{y}_{i}^{2} ( {Ax}_{i}^{2} + {By}_{i}^{2} - 1 )}^{2} = 0 \qquad [ Equation 8 ]$$

$$( \begin{matrix}\sum {w}_{i} {x}_{i}^{4} & \sum {w}_{i} {x}_{i}^{2} {y}_{i}^{2} \\ \sum {w}_{i} {x}_{i}^{2} {y}_{i}^{2} & \sum {w}_{i} {y}_{i}^{4}\end{matrix} ) ( \begin{matrix}A \\ B\end{matrix} ) = ( \begin{matrix}\sum {w}_{i} {x}_{i}^{2} \\ \sum {w}_{i} {y}_{i}^{2}\end{matrix} ) \qquad [ Equation 9 ]$$

$$( \begin{matrix}A \\ B\end{matrix} ) = {( \begin{matrix}\sum {w}_{i} {x}_{i}^{4} & \sum {w}_{i} {x}_{i}^{2} {y}_{i}^{2} \\ \sum {w}_{i} {x}_{i}^{2} {y}_{i}^{2} & \sum {w}_{i} {y}_{i}^{4}\end{matrix} )}^{- 1} ( \begin{matrix}\sum {w}_{i} {x}_{i}^{2} \\ \sum {w}_{i} {y}_{i}^{2}\end{matrix} ) \qquad [ Equation 10 ]$$

Through the above equations, the ellipse parameters A and B may be represented by the following Equation 11.

$$∴ A = \frac{\sum {w}_{i} {y}_{i}^{4} \sum {w}_{i} {x}_{i}^{2} - \sum {w}_{i} {x}_{i}^{2} {y}_{i}^{2} \sum {w}_{i} {y}_{i}^{2}}{\sum {w}_{i} {x}_{i}^{4} \sum {w}_{i} {y}_{i}^{4} - {( \sum {w}_{i} {x}_{i}^{2} {y}_{i}^{2} )}^{2}} , \qquad [ Equation 11 ]$$

$$B = \frac{\sum {w}_{i} {x}_{i}^{4} \sum {w}_{i} {y}_{i}^{2} - \sum {w}_{i} {x}_{i}^{2} {y}_{i}^{2} \sum {w}_{i} {x}_{i}^{2}}{\sum {w}_{i} {x}_{i}^{4} \sum {w}_{i} {y}_{i}^{4} - {( \sum {w}_{i} {x}_{i}^{2} {y}_{i}^{2} )}^{2}}$$

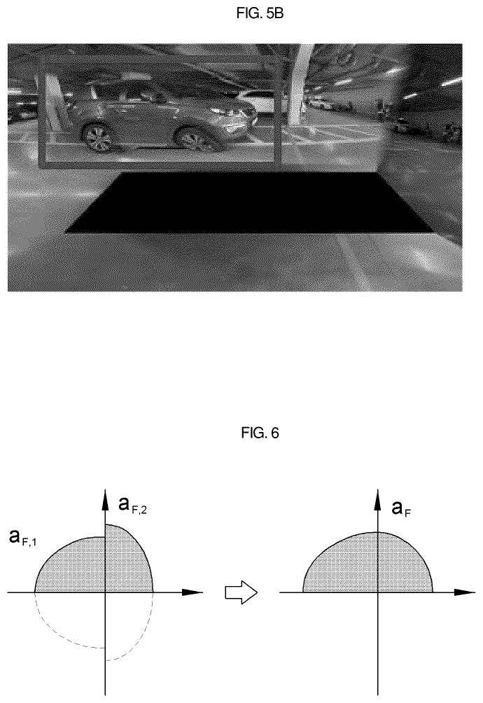

FIGS. 5A and 5B are views showing distortion of the wall of the background model of the 3D SVM and the position of an object according to one embodiment of the present disclosure, with FIG. 5A showing a case in which positions of an actual object and a background wall are different and FIG. 5B showing a case in which the positions of the actual object and the background wall are similar.

A first weight used to accumulate each squared error to calculate the parameters of each partial ellipse is determined using Equations 5 and 6 and the following Equation 12 (determining a data squared error weight).

$$\vert {X}_{i} \vert = \sqrt{{x}_{i}^{2} + {y}_{i}^{2}} , {w}_{i} = \frac{1 / \vert {X}_{i} \vert}{\sum k \frac{1}{\vert {X}_{k} \vert}} \qquad [ Equation 12 ]$$

Generally, distortion of the background model occurs significantly in objects closer to a vehicle body as shown in FIGS. 5A and 5B. In addition, since accurately representing close objects is consistent with the purpose of the SVM function, the weight needs to have a greater value for data points closer to the origin. Accordingly, Equation 12 that determines the first weight may be any function that is inversely proportional to the distance from the origin.

FIG. 6 is a schematic view showing a process of additionally correcting the ellipse parameters of the background model of the 3D SVM according to one embodiment of the present disclosure.

When the parameters of each partial ellipse are determined using independent data, adjacent ellipses may be misaligned at their joints as shown in FIG. 6. In this case, the parameters may be corrected using a second weighted sum as shown in the following Equation 13.

$${a}_{F} = {w}_{F , 1} {a}_{F , 1} + {w}_{F , 2} {a}_{F , 2} \qquad [ Equation 13 ]$$

In this case, the second weight multiplied to each parameter may be any function that is inversely proportional to a length as shown in the following Equations 14 and 15.

$${w}_{F , 1} = \frac{1 / {a}_{F , 1}}{1 / {a}_{F , 1} + 1 / {a}_{F , 2}} \qquad [ Equation 14 ]$$

$${w}_{F , 2} = \frac{1 / {a}_{F , 2}}{1 / {a}_{F , 1} + 1 / {a}_{F , 2}} \qquad [ Equation 15 ]$$

The method of modifying a background model of a 3D SVM in conjunction with a distance sensor according to one embodiment of the present disclosure may be provided as a computer program stored on a computer-readable recording medium for execution on a computer. The medium may permanently store a computer-executable program or temporarily store the computer-executable program for execution or download. In addition, the medium may be various recording or storage unit as a single component or multiple hardware components coupled together and is not limited to a medium directly connected to a specific computer system, but may be distributed across a network. Examples of media may include magnetic media such as a hard disk, a floppy disk, and a magnetic tape, optical recording media such as a CD-ROM and a DVD, magneto-optical media such as a floptical disk, and media configured to store program instructions by including a ROM, a RAM, a flash memory, etc. In addition, examples of other media may include recording or storage media managed by app stores that distribute applications, websites that supply or distribute various software, servers, etc.

The methods, operations, or techniques of the present disclosure may be implemented by various units. For example, these techniques may be implemented in hardware, firmware, software, or a combination thereof. Those skilled in the art will understand that various exemplary algorithm operations described in connection with the present disclosure may be implemented in electronic hardware, computer software, or a combination thereof. To clearly describe such interchangeability of hardware and software, various exemplary operations have been described above generally in terms of their functionality. Whether these functions are implemented as hardware or software will vary depending on a specific application and design requirements imposed on the overall system. Those skilled in the art may implement the functions described in various ways for each specific application, but such implementations should not be construed as limiting the scope of the present disclosure.

In hardware implementation, a processing unit used to perform the techniques may be implemented within one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, electronic devices, other electronic units designed to perform the functions described herein, computers, or a combination thereof.

Accordingly, various exemplary operations described in connection with the present disclosure may be implemented or performed by any combination of a general-purpose processor, a DSP, an ASIC, an FPGA or other programmable logic device, discrete gate or transistor logic, discrete hardware components, or those designed to perform the functions described herein. The general-purpose processor may be a microprocessor, but alternatively, the processor may be any conventional processor, controller, microcontroller, or state machine. The processor may also be implemented as a combination of computing devices, e.g., a combination of a DSP and a microprocessor, a plurality of microprocessors, one or more microprocessors in conjunction with a DSP core, or any combination thereof.

In firmware and/or software implementations, the techniques may be implemented as instructions stored on a computer-readable medium, such as a RAM, a ROM, a non-volatile random access memory (NVRAM), a programmable read-only memory (PROM), an erasable programmable ROM (EPROM), an electrically erasable PROM (EEPROM), a flash memory, a compact disc (CD), a magnetic or optical data storage device, etc. The instructions may be executable by one or more processors and may cause the processor(s) to perform specific aspects of the functions described herein.

When implemented in software, the operations may be stored on or transmitted over a computer-readable medium as one or more instructions or code. The computer-readable media includes both computer storage media and communication media in addition to any medium that facilitates transfer of a computer program from one place to another. The storage media may be any available media that may be accessed by a computer. As a non-limited example, such computer-readable media may include a RAM, a ROM, an EEPROM, a CD-ROM or other optical disk storage, a magnetic disk storage or other magnetic storage devices, or any other medium that may be used to carry or store desired program code in the form of instructions or data structures and that may be accessed by a computer. In addition, any connection is appropriately referred to as a computer-readable medium.

For example, when the software is transmitted from a website, a server, or other remote source using a coaxial cable, a fiber optic cable, a twisted pair, a digital subscriber line (DSL), or wireless technologies such as infrared, radio, and microwave, the coaxial cable, the fiber optic cable, the twisted pair, the digital subscriber line, or the wireless technologies such as infrared, radio, and microwave are included within the definition of media. The terms “disk” and “disc” as used herein include a CD, a laser disc, an optical disc, a DVD, a floppy disk, and a Blu-ray disc, in which disks typically reproduce data magnetically, while discs reproduce data optically using lasers. The above combinations should also be included within the scope of computer-readable media.

A software module may reside in a RAM, a flash memory, a ROM, an EPROM, an EEPROM, registers, a hard disk, a removable disk, a CD-ROM, or any other form of storage medium known in the art. An exemplary storage medium may be coupled to the processor such that the processor may read information from, and write information to, the storage medium. Alternately, the storage medium may be integrated with the processor. The processor and the storage medium may reside within an ASIC. The ASIC may reside in a user terminal. Alternatively, the processor and the storage medium may reside as discrete components in a user terminal.

While the above embodiments have been described as using aspects of the presently disclosed subject matter in one or more standalone computer systems, the present disclosure is not limited thereto and may be implemented in conjunction with any computing environment, such as a network or distributed computing environment. Furthermore, aspects of the subject matter of the present disclosure may be implemented in multiple processing chips or devices, and the storage may be similarly affected across multiple devices. Such devices may include PCs, network servers, and portable devices.

According to the method of the present disclosure, the following effects can be obtained.

By realistically representing the background model of the 3D SVM, it is possible to improve the reliability of the SVM screen, thereby enhancing the quality of products manufactured using it.

In addition, it is possible to improve stability by preventing misrecognition of the positions of objects around the vehicle.

Embodiments according to the present disclosure are not limited to those described above, and various alternatives, modifications, and variations may be implemented within the scope that is apparent to those skilled in the art.

What is claimed is:

1. A method of modifying a background model of a 3D surround view monitor (SVM) in conjunction with a distance sensor, wherein each operation is performed by at least one processor of a computer system, the method comprising:
receiving distance information collected through an ultrasonic sensor;
converting the received distance information from the ultrasonic sensor into two-dimensional coordinates using external parameters of the ultrasonic sensor;
determining a shape of a bottom surface of a background model of a 3D SVM according to the two-dimensional coordinates;
generating the background model of the 3D SVM based on the shape of the bottom surface;
generating a vehicle model of the 3D SVM based on vehicle data and the background model of the 3D SVM;
determining whether to activate a parking distance warning (PDW) function based on the received distance information from the ultrasonic sensor;
generating a PDW graphic when the PDW function is activated;
coupling a 3D SVM screen with a PDW screen; and
outputting the 3D SVM.

2. The method of claim 1, wherein the receiving of the distance information collected through the ultrasonic sensor includes collecting surrounding environment data using a plurality of ultrasonic sensors.

3. The method of claim 1, wherein the converting of the ultrasonic sensor distance information into the two-dimensional coordinates using the external parameters of the ultrasonic sensor is performed through calculation using the following equations:
$${x}_{i}^{o} = {x}_{i}^{s} + d \times cos θ ,$$
$${y}_{i}^{o} = {y}_{i}^{s} + d \times sin θ ,$$
where x^{o}ᵢ and y^{o}ᵢ are two-dimensional position coordinate values of an object, x^{s}ᵢ and y^{s}ᵢ are two-dimensional position coordinate values of a sensor, d is the distance information, and θ is a sensor optical axis angle.

4. The method of claim 1, wherein the determining of the shape of the bottom surface of the background model of the 3D SVM according to the two-dimensional coordinates includes dividing the two-dimensional coordinates acquired from the ultrasonic sensor into four groups according to quadrants of a two-dimensional coordinate system with a center of a vehicle as an origin and partially coupling four ellipses each having different parameters according to the four groups to determine the shape of the bottom surface.

5. The method of claim 4, wherein an equation of an ellipse in a second quadrant in the two-dimensional coordinate system divided into the four groups is defined as the following equation:
$${Ax}^{2} + {By}^{2} = 1 ( A = \frac{1}{{a}_{L}^{2}} , B = \frac{1}{{a}_{F}^{2}} ) ,$$
where a_{L} and a_{F} are half lengths of major and minor axes of the partial ellipse of the second quadrant, respectively, and
after calculating a squared error for the two-dimensional data and calculating a total squared error by adding a first weight that is inversely proportional to the distance information, ellipse parameters A and B are determined using a least squares error technique.

6. The method of claim 4, wherein, when adjacent ellipses among the four ellipses having different parameters according to the four groups are misaligned at their joints, the parameters are corrected using the following equation:
$${a}_{F} = {w}_{F , 1} {a}_{F , 1} + {w}_{F , 2} {a}_{F , 2}$$
where a_{F,1} and a_{F,2} are lengths of the adjacent ellipses in a y-axis direction, respectively, and w_{F,1} and w_{F,2} are second weights that are inversely proportional to the lengths of the ellipses in the y-axis direction.

7. The method of claim 6, wherein the second weight is defined as the following equation:
$${w}_{F , 1} = \frac{1 / {a}_{F , 1}}{1 / {a}_{F , 1} + 1 / {a}_{F , 2}}$$
$${w}_{F , 2} = \frac{1 / {a}_{F , 2}}{1 / {a}_{F , 1} + 1 / {a}_{F , 2}}$$

8. The method of claim 1, wherein the determining of whether to activate the PDW function includes comparing a distance to an obstacle measured by the ultrasonic sensor with a preset safety distance to determine whether the obstacle exceeds the safety distance.

9. The method of claim 8, wherein the PDW graphic generated upon activation of the PDW function visually provides a position and distance of the obstacle on a PDW screen.

10. The method of claim 1, wherein the coupling of the 3D SVM screen to the PDW screen includes additionally coupling PDW information on the 3D SVM screen including the background model of the 3D SVM and the vehicle model of the 3D SVM.

11. A device for modifying a background model of a 3D surround view monitor (SVM) in conjunction with a distance sensor, which is implemented by at least one processor of a computer system to perform the operations of the method claim 1.

12. A non-transitory computer-readable recording medium that stores a computer program for executing the method of claim 1 in a computer system.

13. A device for modifying a background model of a 3D surround view monitor (SVM) in conjunction with a distance sensor, the device comprising:
one or more processors; and
a memory storing instructions that, when executed by the one or more processors, cause the device to:
receive distance information collected through an ultrasonic sensor;
convert the received distance information from the ultrasonic sensor into two-dimensional coordinates using external parameters of the ultrasonic sensor;
determine a shape of a bottom surface of a background model of a 3D SVM according to the two-dimensional coordinates;
generate the background model of the 3D SVM based on the shape of the bottom surface;
generate a vehicle model of the 3D SVM based on vehicle data and the background model of the 3D SVM;
determine whether to activate a parking distance warning (PDW) function based on the received distance information from the ultrasonic sensor;
generate a PDW graphic when the PDW function is activated;
couple a 3D SVM screen with a PDW screen; and output the 3D SVM.
